(19) United States
(12) Patent Application Publication
(10) Pub. No.: US 2010/0266081 A1
(43) Pub. Date: Oct. 21, 2010

(54) System and Method for Double Rate Clocking Pulse Generation With Mistrack Cancellation

(75) Inventors: Gary S. Ditlow, Garrison, NY (US); Robert Kevin Montoye, Rochester, MN (US); Salvatore Nicholas Storino, Rochester, MN (US)

Correspondence Address: Cahn & Samuels, LLP, 1100 17th St., NW, Ste. 401, Washington, DC, 20036, US

(73) Assignee: INTERNATIONAL BUSINESS MACHINES CORPORATION, Armonk, NY (US)

(21) Appl. No.: 12/427,218

(22) Filed: Apr. 21, 2009

(51) Int. Cl. H04L 7/00

(52) U.S. Cl. 375/371

(57) ABSTRACT

A method for generating a dual rate clock circuit the method including coupling the output terminal of a first local clock buffer to the input of a second local clock buffer through at least one inverter circuit and driving the first local clock buffer with a base signal. The method also includes generating an early clock signal with the first local clock buffer based on the base signal and generating a delayed early clock signal by delaying the first local clock signal with the at least one inverter. The method also includes generating a later clock signal by driving the second local clock buffer with the delayed early clock signal wherein the second local clock buffer and the late clock signal generated by the second local clock buffer are synchronized and correlated with the first local clock buffer and the early clock signal generated by the first local clock buffer.

### FIELD OF THE INVENTION

This invention relates in general to a system and method for generating a double rate clock and specifically to a system and method for generating a correlated double rate clock pulse.

### BACKGROUND OF THE INVENTION

The generation of dual rate clocks require two local clock buffers (LCB) where the first fires directly off of a base clock signal but the second requires a delay chain from the base clock signal. The first LCB generates an early clock signal. The second LCB employing the delay chain used to generate a late clock signal. This delay chain is on the second LCB and typically does not share a path with the first LCB. Since the delay chain is not a common path or on related paths any variations in the first LCB are not common in the second LCB or the delay chain. Depending on the variations in the first and second LCB operation, ie switching time, pulse duration etc, thus mistracking can easily and often occurs.

FIGS. 1 and 2 illustrate the traditional method of generating a dual rate clock. With reference to FIG. 1, a base clock signal is coupled to the input terminal 105 of a first LCB 110. The base clock signal drives the first LCB 110. The first LCB 110 generates a pulse used as the early clock signal. The base clock signal is also coupled to a delay circuit 120, typically employing a plurality of inverters 121. These inverters delay impart a delay or a separation in the pulses of the base clock signal. This delayed base clock signal is coupled into the input terminal 125 of a second LCB 110′ and is used to drive the second LCB 110′. The second LCB 110′ generates a pulse used as the late clock signal.

FIG. 2 shows a waveform representation of the relationship of the base clock signal with the early and late pulses generated by the first and second LCB, respectively. Each LCB generates a pulse responsive to the falling edge of the base clock signal 205. Upon detecting the falling edge of the base clock signal 205, the first LCB generates a pulse 215. This pulses is used as the early clock pulse. The base clock signal is delayed and upon the second LCB receipt of the delayed base clock signal 205, the second LCB generates a second pulse reflecting the delay 235. This pulse is used as the late clock pulse.

As illustrated in FIG. 1 and FIG. 2 the first and second LCB generate pulses in response to a base signal that is received by the respective LCB through different paths. Thus variations in the paths, variations in the response times of the first and second LCB and variations in the operation of the delay circuit can make the early and late pulses converge or diverge independently. Since the first and second LCB vary independently of each other, mistracking often occurs. This independent variation of the first and second LCB, and the resulting independent variation of the clock signals generated from the first and second LCB necessarily make correlation and synchronization of the clock signals difficult.

### SUMMARY OF THE INVENTION

Disclosed is a dual rate clock circuit comprising a first local clock buffer having an input terminal and an output terminal, at least one inverter circuit and a second local clock buffer having an input terminal and an output terminal. The input terminal of the second local clock buffer is coupled to the output terminal of the first local clock buffer trough at least one inverter circuit wherein the first local buffer is driven with a base signal received through the first local buffer input terminal, and upon the base signal changing from a high state to a low state, the first local buffer circuit generating an early (first) clock pulse at the first local clock buffer output terminal, the at least one inverter delaying the early (first) pulse, the second local clock buffer being driven by the delayed early (first) clock pulse and generating a late (second) clock pulse at the second local clock buffer output terminal the late (second) clock pulse being synchronized and substantially correlated with the early (first) clock pulse.

Also disclosed is a method for generating a dual rate clock circuit the method including coupling the output terminal of a first local clock buffer to the input of a second local clock buffer through at least one inverter circuit and driving the first local clock buffer with a base signal. The method also includes generating an early clock signal with the first local clock buffer based on the base signal and generating a delayed early clock signal by delaying the first local clock signal with the at least one inverter. The method also includes generating a later clock signal by driving the second local clock buffer with the delayed early clock signal wherein the second local clock buffer and the late clock signal generated by the second local clock buffer are synchronized and correlated with the first local clock buffer and the early clock signal generated by the first local clock buffer.

In the detailed description, references to “one embodiment”, “an embodiment”, or “in embodiments” mean that the feature being referred to is included in at least one embodiment of the invention. Moreover, separate references to “one embodiment”, “an embodiment”, or “in embodiments” do not necessarily refer to the same embodiment; however, neither are such embodiments mutually exclusive, unless so stated, and except as will be readily apparent to those skilled in the art. Thus, the invention can include any variety of combinations and/or integrations of the embodiments described herein.

Given the following enabling description of the drawings, the method should become evident to a person of ordinary skill in the art.

### BRIEF DESCRIPTION OF THE DRAWINGS

In order to describe the manner in which the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings.

FIG. 1 illustrates an exemplarily block diagram of the traditional method of generating a dual rate clock.

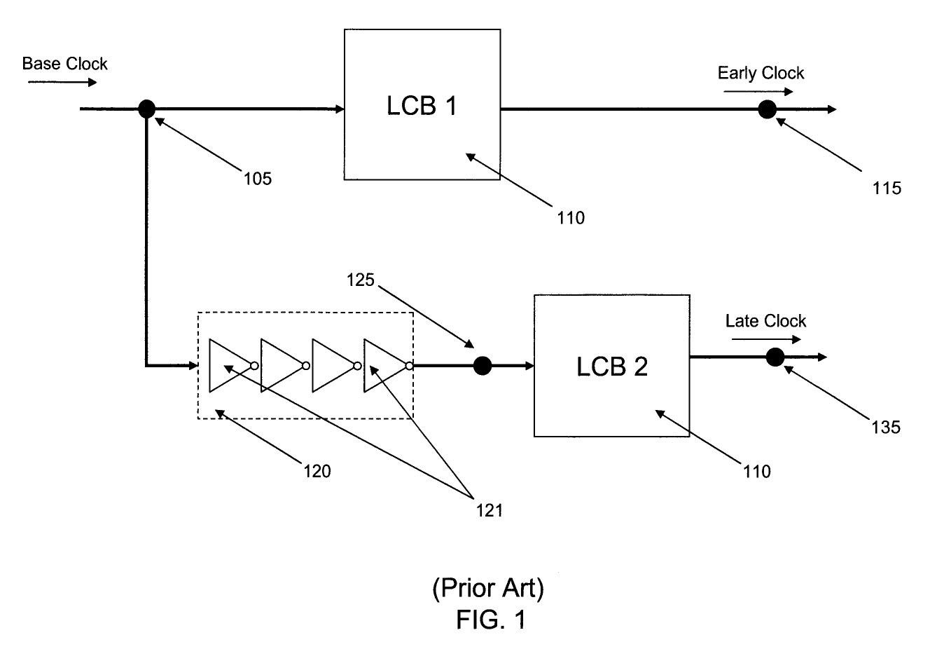

FIG. 2 illustrates an exemplarily diagram showing the relationship of the base clock signal with the early and late pulses generated by the first and second LCB of the prior art.

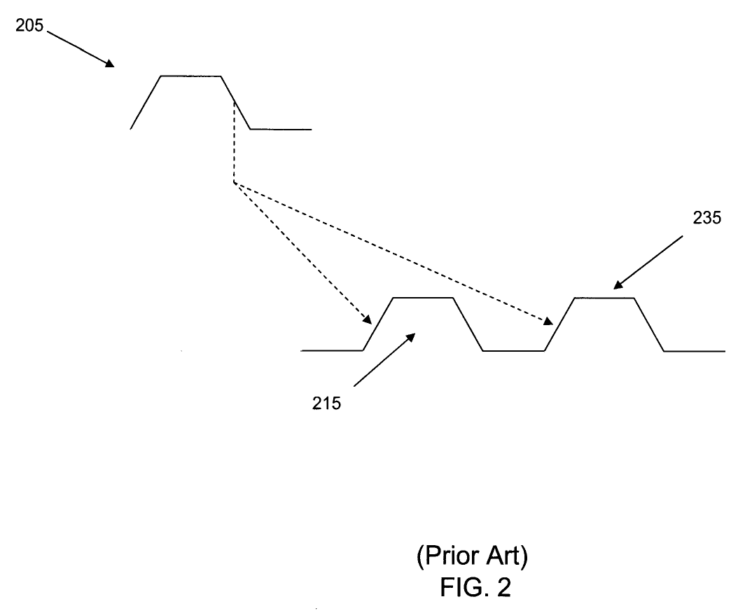

FIG. 3 illustrates an exemplarily block diagram of a system for generating a dual rate clock according to the present invention.

FIG. 4 illustrates an exemplarily diagram showing the relationship of the base clock signal with the early and late pulses generated by the first and second LCB of the present invention.

### DETAILED DESCRIPTION

Various embodiments are discussed in detail below. While specific implementations of the disclosed technology are discussed, it should be understood that this is done for purposes of illustration. A person skilled in the relevant art will recognize that other components and configurations may be used without departing from the spirit and scope of the invention.

In order to reduce the incidence of mistracking and prevent divergent or convergent variations in a dual rate clock, the disclosed invention incorporates a common pathway along which the early clock pulse and the late clock pulse are generated. This shared logic, enables the generation of a highly correlated dual rate clock.

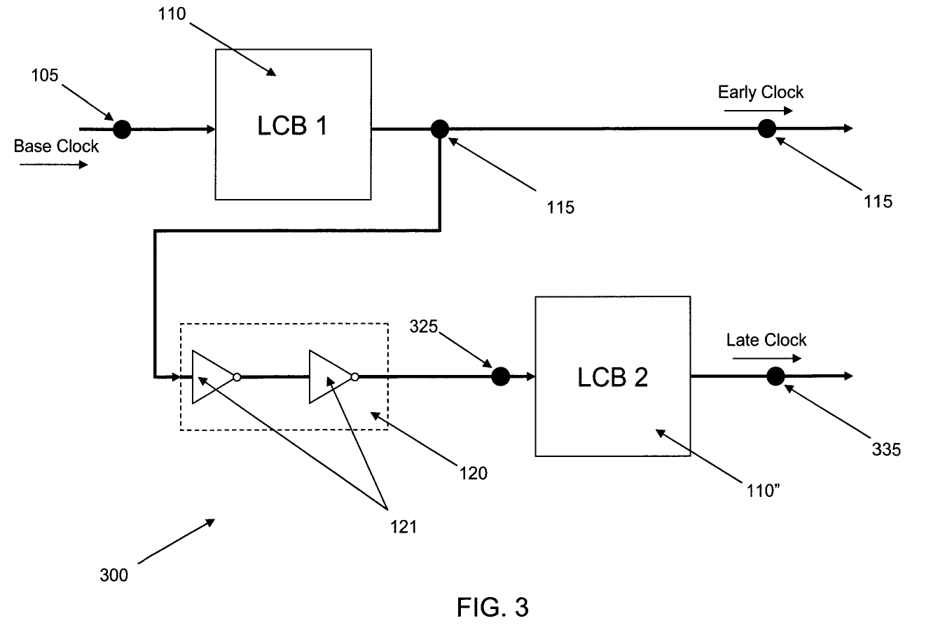

Referring to the Figures, wherein like elements are denoted by like find numbers, FIG. 3, shows an exemplarily block diagram of a system of generating a dual rate clock according to the present invention. The dual rate clock circuit 300 shown in FIG. 3 comprises a first local clock buffer 110 having an input terminal 105 and an output terminal 115, a delay circuit 120 and a second local clock buffer 110′ having an input terminal 325 and an output terminal 335. The input terminal 325 of the second local clock buffer 110′ is coupled to the output terminal 115 of the first local clock buffer 110 trough the delay circuit 120. The delay circuit 120 can contain a plurality of inverter circuits 121. The first local buffer 110 is driven with a base signal received through the first local buffer input terminal 105. When the base signal changes from a high state to a low state, the first local buffer circuit 110 generates a first clock pulse at the first local clock buffer 110 output terminal 115. This first clock pulse is used as the early clock. The delay circuit 120 receives the first clock pulse and delays the early (first) pulse. The delay circuit 120 provides a portion of the desired separation between early and late pulses.

The second local clock buffer 110′ is driven by the delayed early (first) clock pulse and generates a second clock pulse at the output terminal 335 of second local clock buffer 110. The second clock pulse is employed as the late (second) clock pulse and is synchronized and substantially correlated with the early (first) clock pulse generated by the first local clock buffer 110. Since the pulse generated by the second local clock buffer is generated as a response to the pulse received by the first local clock buffer the early and late pulse are highly correlated in that any timing variations of the early signal are also reflected in the late pulse.

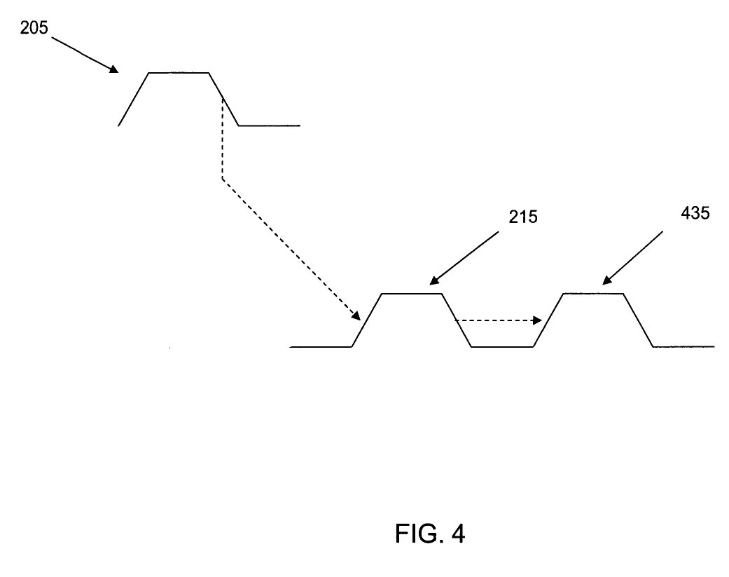

FIG. 4 illustrates an exemplarily diagram showing the relationship of the base clock signal with the early and late pulses generated by the first and second local clock buffers of the present invention as shown in the example embodiment of FIG. 3. Referring now to FIG. 4 with continued reference to FIG. 3, the base clock signal 205 is received at the input terminal 105 of the first local clock buffer 110. Upon detecting the change in state from high to low, specifically the trailing edge of the base clock signal, the first local clock buffer generates a pulse 215 at the first local clock buffer's output terminal 115. The pulse 215 generated by the first local clock buffer 110, in response to the change in state of the base clock signal 205, is employed as the early clock signal. The pulse 215 generated by the first local clock buffer 110 is delayed by the delay circuit and that delayed signal is used drive the second local clock buffer 110′. The second local clock buffer 110′ generates a pulse 435 in response to the falling edge of the pulse 215 generated by the first local clock buffer 110. This pulse is employed as the late clock. Since the first and second clock buffer both have this common logic, the second pulse 435 is generated in response to the second clock buffer's receipt of the first pulse 215 from the first clock buffer, any variation in the first pulse is reflected in the second pulse 435. Thus these clock pulses are highly correlated.

Another advantage of the disclose dual rate clock structure is a significant reduction in the number of components necessary to create a proportional separation between the early clock and the late clock generated by the dual rate clock. Specifically, to create a desired delay, the delay circuit typically employs a plurality of inverters to generate the desired delay in the pulse signal driving the second local clock buffer 110′. Each of these inverter components adds complexity to the dual rate clock circuit. The disclosed dual rate clock structure uses the switching time of the first local clock buffer to inject a portion of the separation of the first and second pulses. The switching time is the lag between the detection of the falling edge of the drive signal by the first local clock buffer, and first local clock buffers generation of the pulse in response thereto.

In yet another embodiment the invention resides in a method for generating a dual rate clock circuit the method including coupling the output terminal of a first local clock buffer to the input of a second local clock buffer through at least one inverter circuit and driving the first local clock buffer with a base signal. The method also includes generating an early clock signal with the first local clock buffer based on the base signal and generating a delayed early clock signal by delaying the first local clock signal with the at least one inverter. The method also includes generating a later clock signal by driving the second local clock buffer with the delayed early clock signal wherein the second local clock buffer and the late clock signal generated by the second local clock buffer are synchronized and correlated with the first local clock buffer and the early clock signal generated by the first local clock buffer.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

In yet another example embodiment the disclosed invention resides in a computer program product comprising computer usable medium for generating a dual rate clock circuit including computer program code for coupling the output terminal of a first local clock buffer to the input of a second local clock buffer through at least one inverter circuit and computer driving the first local clock buffer with a base signal. The computer program product also includes computer program code for generating an early clock signal with the first local clock buffer based on the base signal and computer usable program code for generating a delayed early clock signal by delaying the first local clock signal with the at least one inverter. The computer program product also includes computer program code for generating a later clock signal by driving the second local clock buffer with the delayed early clock signal wherein the second local clock buffer and the late clock signal generated by the second local clock buffer are synchronized and correlated with the first local clock buffer and the early clock signal generated by the first local clock buffer.

The invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Computer program code for carrying out operations of the present invention may be written in a variety of computer programming languages. The program code may be executed entirely on at least one computing device, as a stand-alone software package, or it may be executed partly on one computing device and partly on a remote computer. In the latter scenario, the remote computer may be connected directly to the one computing device via a LAN or a WAN (for example, Intranet), or the connection may be made indirectly through an external computer (for example, through the Internet, a secure network, a sneaker net, or some combination of these).

It will be understood that each block of the flowchart illustrations and block diagrams and combinations of those blocks can be implemented by computer program instructions and/or means. These computer program instructions may be provided to a processor of at least one general purpose computer, special purpose computer(s), or other programmable data processing apparatus to produce a machine, such that the instructions, which execute via the processor of the computer or other programmable data processing apparatus, create means for implementing the functions specified in the flowcharts or block diagrams.

The exemplary and alternative embodiments described above may be combined in a variety of ways with each other. Furthermore, the steps and number of the various steps illustrated in the figures may be adjusted from that shown.

Although the present invention has been described in terms of particular exemplary and alternative embodiments, it is not limited to those embodiments. Alternative embodiments, examples, and modifications which would still be encompassed by the invention may be made by those skilled in the art, particularly in light of the foregoing teachings.

1. A method for generating a dual rate clock circuit said method comprising:
coupling the output terminal of a first local clock buffer to the input of a second local clock buffer through at least one inverter circuit;
driving said first local clock buffer with a base signal;
generating an early clock signal with said first local clock buffer based on said base signal;
generating a delayed early clock signal by delaying said first local clock signal with said at least one inverter;
generating a later clock signal by driving said second local clock buffer with said delayed early clock signal;
wherein said second local clock buffer and said late clock signal generated by said second local clock buffer are synchronized and correlated with said first local clock buffer and said early clock signal generated by said first local clock buffer.
